(19) United States
(12) Patent Application Publication
(10) Pub. No.: US 2013/0260183 A1
(43) Pub. Date: Oct. 3, 2013

(54) THREE DIMENSIONAL SOLID-STATE BATTERY INTEGRATED WITH CMOS DEVICES

(71) Applicants: John Ellis-Monaghan, Essex Junction, VT (US); Jeffrey P. Gambino, Essex Junction, VT (US); Kirk D. Peterson, Essex Junction, VT (US); Jed Hickory Rankin, Essex Junction, VT (US)

(72) Inventors: John Ellis-Monaghan, Essex Junction, VT (US); Jeffrey P. Gambino, Essex Junction, VT (US); Kirk D. Peterson, Essex Junction, VT (US); Jed Hickory Rankin, Essex Junction, VT (US)

(73) Assignee: INTERNATIONAL BUSINESS MACHINES CORPORATION, ARMONK, NY (US)

(21) Appl. No.: 13/432,353

(22) Filed: Mar. 28, 2012

(51) Int. Cl. H01M 2/00; G06F 19/00

(52) U.S. Cl. 429/7; 29/623.1; 702/63

(57) ABSTRACT

A solid-state battery structure having a plurality of battery cells formed in a substrate. The plurality of battery cells includes a first current collector layer overlying a first insulating layer and a first electrode layer overlying the first current collector layer. The battery structure further includes a second current collector layer overlying a patterned second electrode layer. The patterned second electrode layer overlies the substrate and forms a plurality of sub-arrays of the battery cells. The battery structure further includes a second insulating layer overlying the second current collector layer. The second insulating layer substantially laterally surrounds first and second contact pads. The first pad is electrically connected to the first current collector layer and the second pad is electrically connected to the second current collector layer. The first and second contact pads are in electrical communication, through at least two electrical wires, with a circuit located upon the substrate.

### BACKGROUND

### Field of the Invention

The present invention relates to solid-state batteries, and more particularly, to a solid-state battery integrated with complementary metal-oxide-semiconductor (CMOS) devices on a same chip, method of manufacturing the same and design structure thereof.

An electrochemical battery is a device that converts chemical energy into electrical energy. An electrochemical battery typically consists of a group of electric cells that are connected to act as a source of direct current. Generally, an electric cell consists of three dissimilar substances, a positive electrode, typically called the cathode, a negative electrode, typically called the anode, and a third substance, an electrolyte. The positive and negative electrodes conduct electricity. The electrolyte acts chemically on the electrodes. The electrolyte functions as an ionic conductor for the transfer of the electrons between the electrodes. Thus, a cell is a galvanic unit that converts chemical energy (ionic energy) to electrical energy.

Electrochemical energy sources based on solid-state electrolytes are known in the art. These (planar) energy sources, or ‘solid-state batteries’, efficiently convert chemical energy into electrical energy and can be used as the power sources for portable electronics. At small scale such batteries can be used to supply electrical energy to, for example, microelectronic modules. Small-sized integrated batteries are expected to become increasingly important in our daily lives as new application areas arise like implantable devices, small autonomous devices, smart cards, integrated lighting solutions (OLEDs) or hearing aids. These low-power and small-volume applications require batteries with a large volumetric energy/power density. The gravimetric energy/power density is of minor importance due to the small size. Therefore, excellent candidates to power these applications are thin-film all solid-state batteries.

Currently, several designs of three dimensional (3D) solid-state batteries have already been described and disclosed in the prior art. It is desirable to integrate a solid-state battery with a CMOS circuit.

### SUMMARY

In an aspect of the invention, a battery structure comprises a plurality of battery cells formed in a substrate. The plurality of battery cells comprises a first current collector layer overlying a first insulating layer and a first electrode layer overlying the first current collector layer. The battery structure further comprises a second current collector layer overlying a patterned second electrode layer. The patterned second electrode layer overlies the substrate and forms a plurality of sub-arrays of the battery cells The battery structure further comprises a second insulating layer overlying the second current collector layer. The second insulating layer substantially laterally surrounds first and second contact pads. The first contact pad is electrically connected to the first current collector layer and the second contact pad is electrically connected to the second current collector layer. The first contact pad and the second contact pad are in electrical communication, through at least two electrical wires, with a circuit located upon the substrate.

In another aspect of the invention, a method for fabricating a battery structure comprises forming a plurality of battery cells in a substrate. The plurality of battery cells comprise a first insulating layer and a first current collector layer. The method further comprises forming a second current collector layer overlying the plurality of battery cells. The method further comprises forming a second insulating layer overlying the second current collector layer. The method further comprises forming first and second contact pads in the second insulating layer. The first contact pad is electrically connected to the first current collector layer and the second contact pad is electrically connected to the second current collector layer. The method further comprises connecting the first contact pad and the second pad, through at least two electrical wires, with a circuit located upon the substrate.

In another aspect of the invention, a design structure embodied in a machine readable medium for designing, manufacturing, or testing an integrated circuit is provided. The design structure comprises the structures and/or methods of the present invention.

A more complete understanding of the present invention, as well as further features and advantages of the present invention, will be obtained by reference to the following detailed description and drawings. It is to be understood that both the foregoing general description and the following detailed description are exemplary and explanatory only, and should not be considered restrictive of the scope of the invention, as described and claimed. Further, features or variations may be provided in addition to those set forth herein. For example, embodiments of the invention may be directed to various combinations and sub-combinations of the features described in the detailed description.

### BRIEF DESCRIPTION OF THE SEVERAL VIEWS OF THE DRAWINGS

The present invention is described in the detailed description which follows in reference to the noted plurality of drawings by way of non-limiting examples of exemplary embodiments of the present invention.

FIG. 1 illustrates a perspective view of a solid-state battery in a semiconductor substrate according to the prior art;

FIG. 2 illustrates a cross-section view of the solid-state battery structure of FIG. 1;

FIG. 3 illustrates a top view of a solid-state battery structure in accordance with an embodiment of the present invention;

FIG. 4 illustrates a cross-section view of the solid-state battery structure of FIG. 3;

FIG. 5 illustrates a top view of a solid-state battery structure of FIG. 3 integrated with a circuit on a same substrate in accordance with the embodiment of the present invention;

FIG. 6 illustrates a cross-section view of the integrated structure of FIG. 5; and

FIG. 7 is a flow diagram of a design process used in semiconductor design, manufacture, and/or test.

### DETAILED DESCRIPTION

The present invention relates to a structure of a solid-state battery integrated with complementary metal-oxide-semiconductor (CMOS) devices on a same chip, method of manufacturing the same and design structure thereof. More specifically, the present invention comprises a battery structure having a plurality of battery cells formed in a substrate. The plurality of battery cells comprises a first current collector layer overlying a first insulating layer and a first electrode layer overlying the first current collector layer. The battery structure further comprises a second current collector layer overlying a patterned second electrode layer. The patterned second electrode layer overlies the substrate and forms a plurality of sub-arrays of the battery cells The battery structure further comprises a second insulating layer overlying the second current collector layer. The second insulating layer substantially laterally surrounds first and second contact pads. The first contact pad is electrically connected to the first current collector layer and the second contact pad is electrically connected to the second current collector layer. The first contact pad and the second contact pad are in electrical communication, through at least two electrical wires, with a circuit located upon the substrate. Advantageously, the solid-state battery is electrically isolated from the substrate by the first insulating layer. The structure of the present invention is an improvement over the prior art as it allows the interconnection of the battery with a CMOS circuit utilizing conventional back end of line (BEOL) wiring techniques.

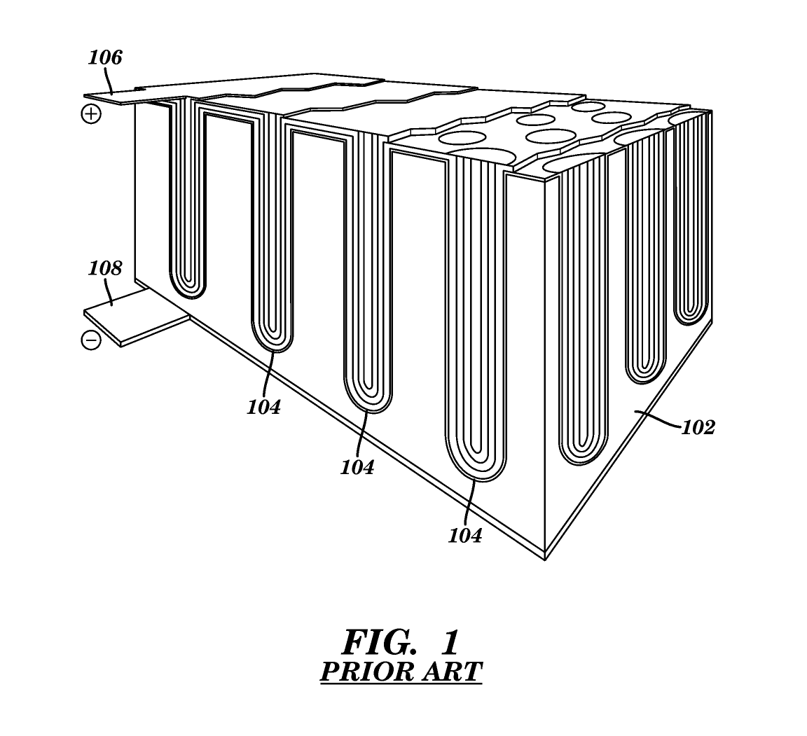

FIG. 1 illustrates a perspective view of a 3D-integrated all-solid-state battery in a semiconductor substrate according to the prior art. In this example, the substrate is made of silicon. This battery system is based on the intercalation of lithium ions as energy-carrying particles because silicon is an excellent intercalation material for lithium. The term “intercalation”, as used herein, refers to a property of a material that allows ions to readily move in and out of the material without the material changing its phase. Accordingly, a solid-state intercalation film remains in a solid state during discharging and charging of a battery. As shown in FIG. 1, a substrate 102 is provided in which a plurality of cells 104 are formed by anisotropically (vertically) etching a plurality of trenches and subsequently depositing the active battery layers inside these cells using conventional techniques. The known 3-D integrated battery structure depicted in FIG. 1 further comprises first current collector layer 108 and second current collector layer 106.

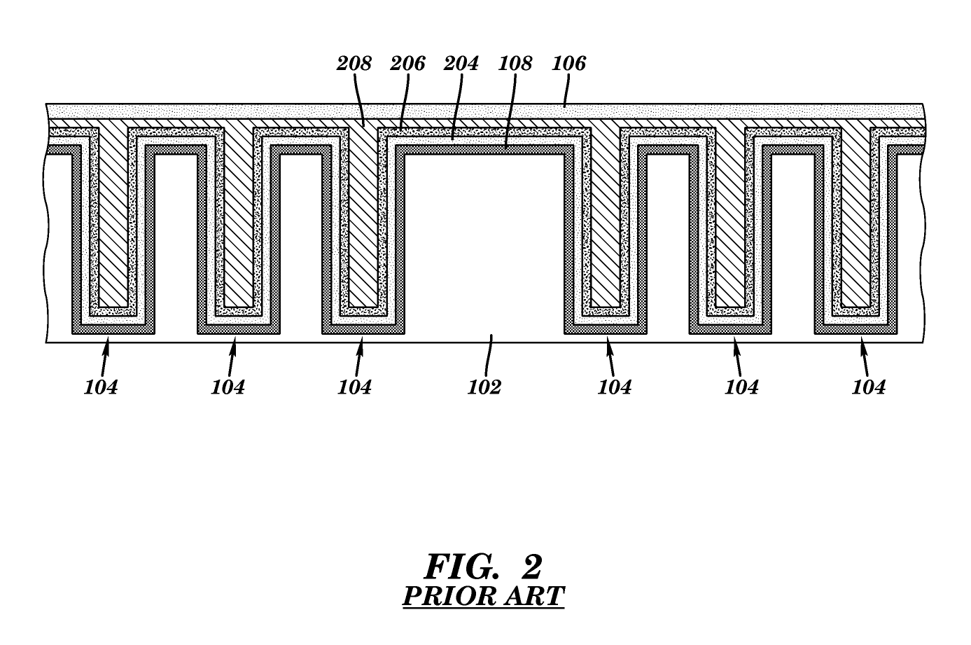

FIG. 2 illustrates a cross-section view of the solid-state battery structure of FIG. 1. Once trenches 104 are formed in substrate 102, a first current collector layer 108 is deposited on sidewalls and the bottom of trenches 104. First current collector layer 108 may also be deposited onto the surface of substrate 102 in between trenches 104. Examples of first current collector layer 108 materials include refractory metals and refractory metal nitrides, such as tantalum (Ta), tantalum nitride (TaN), titanium (Ti), titanium nitride (TiN), tungsten (W), molybdenum (Mo) and combinations thereof. First current collector layer 108 may be deposited by chemical vapor deposition (CVD), physical vapor deposition (PVD) or atomic layer deposition (ALD). In this example, first current collector layer 108 may be deposited to a thickness of approximately 10-5000 nm, and preferably approximately 100 nm. First current collector layer 108 also acts as a chemical barrier layer, since the layer counteracts diffusion of lithium ions. In case lithium ions would leave cells 104 and would enter substrate 102 the performance of the battery would be affected. The battery depicted in FIG. 2 further comprises a first electrode layer 204 which may be deposited onto first current collector layer 108. In this example, first electrode layer 204 comprises a negative electrode (anode electrode) layer. First current collector layer 108 collects current for first electrode layer 204. In this example, first electrode layer 204 is made of a polycrystalline silicon film. Polycrystalline silicon 204 may be deposited by CVD to a thickness of approximately 10-5000 nm, and preferably approximately 1000 nm. After that, the solid-state electrolyte layer 206 may be deposited onto first electrode layer 204. In this example, the solid-state electrolyte material (electrical insulating material) is lithium phosphorous oxynitride (LiPON). However, other ionically conductive solid-state electrolyte materials may be applied, for example, but not limited to lithium germanium oxynitride (LiGeON), lithium orthotungstate (Li₂WO₄), lisicon (Li₁₄ZnGe₄O₁₆), and the like. The layer thickness of the solid-state electrolytic layer 206 is approximately 50-5000 nm, and preferably approximately 100 nm. Deposition of the electrolyte layer 206 may be realized by means of the one of the following techniques: PVD, CVD, or ALD techniques. The battery further comprises a second electrode layer 208 which may be deposited onto the solid-state electrolyte layer 206. In this example, second electrode layer 208 comprises a positive electrode (cathode electrode) layer. Second electrode layer 208 may be made of a thin film material like lithium-cobalt composite oxide (LiCoO₂). Second electrode layer 208 may be deposited by CVD to a thickness of approximately 50-5000 nm, and preferably approximately 1000 nm. Examples of other cathode materials that may be applied include, but are not limited to, conducting oxides, such as V₂O₅, LiMn₂O₄, LiFePO₄. The battery shown in FIG. 2 further comprises a second current collector layer 106 which may be deposited on top of the second electrode layer 208. This layer acts as a current collector for second electrode(cathode electrode) layer 208. Preferably, this second current collector layer 106 is made of at least one of the following metals: aluminum (Al), nickel (Ni), platinum (Pt), gold (Au), silver (Ag), copper (Cu), tantalum (Ta), tantalum nitride (TaN), titanium (Ti), titanium nitride (TiN), and combinations thereof. Second current collector layer 106 may be deposited by

PVD or CVD process to a thickness of approximately 0.1-5 μm, and preferably approximately 1 μm.

During a charge of the battery lithium ions plus an equal number of electrons (Li⁺+e⁻=Li) are extracted from second electrode layer 208 and transported via solid-state electrolyte 206 to first electrode layer 204 where they are intercalated. During discharge the opposite process takes place. The embodiments of the present invention recognize that one of the substantial risks with this type of solid-state battery is that all of the cells 104 are connected together by one continuous second electrode layer 208. A defect in the solid-state electrolyte layer 206 of any cell 104 may result in short-circuiting of first electrode layer 204 and second electrode layer 208. Thus, if any one of the cells 104 used in a battery array becomes faulty due to such an internal shortage or the like, it will cause the whole battery array to become unusable. The various embodiments of the present invention provide a structure and method of forming a solid-state battery with an improved yield and reliability.

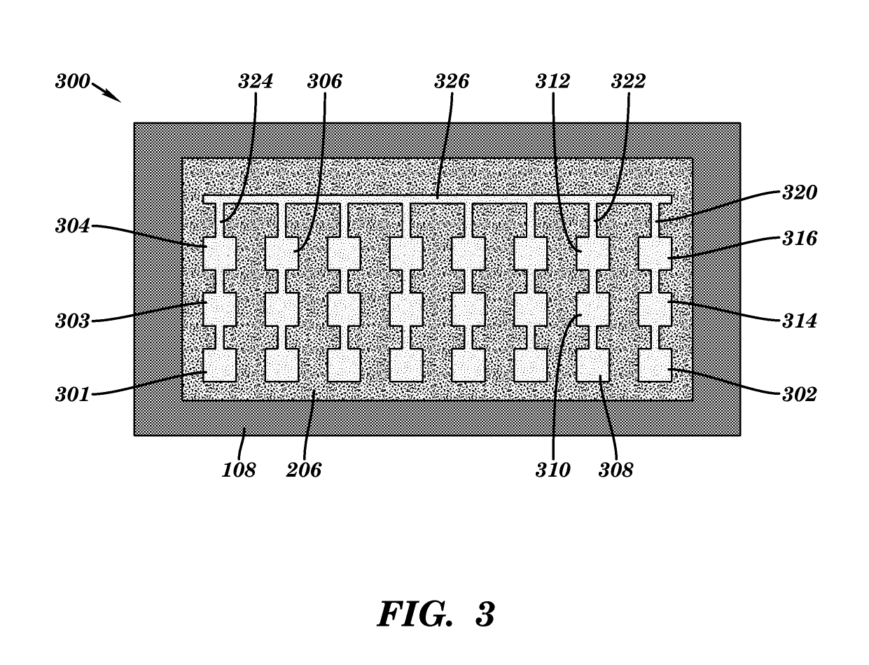

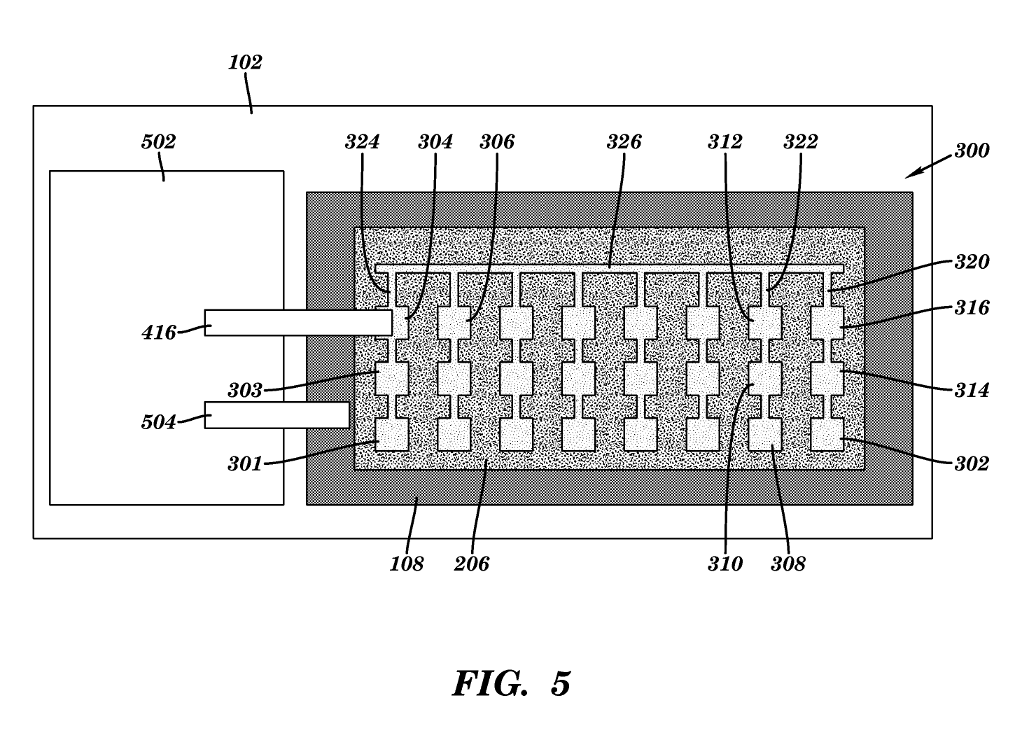

FIG. 3 illustrates a top view of a solid-state battery structure in accordance with an embodiment of the present invention. This embodiment of the present invention provides a fuse connection structure integrated with the battery. The present invention also provides an aspect of a patterned cathode. These two aspects enable one to remove some defective cells 104 in the battery structure 300 without making whole battery unusable. FIG. 3 illustrates a battery cell array 300 divided into a plurality of sub-arrays 301-320 arranged in matrix form (having a plurality of rows and columns). Although only 3 rows and 8 columns are shown in FIGS. 3 and 5 the array 300 in FIGS. 3 and 5 can have any number of rows and columns.

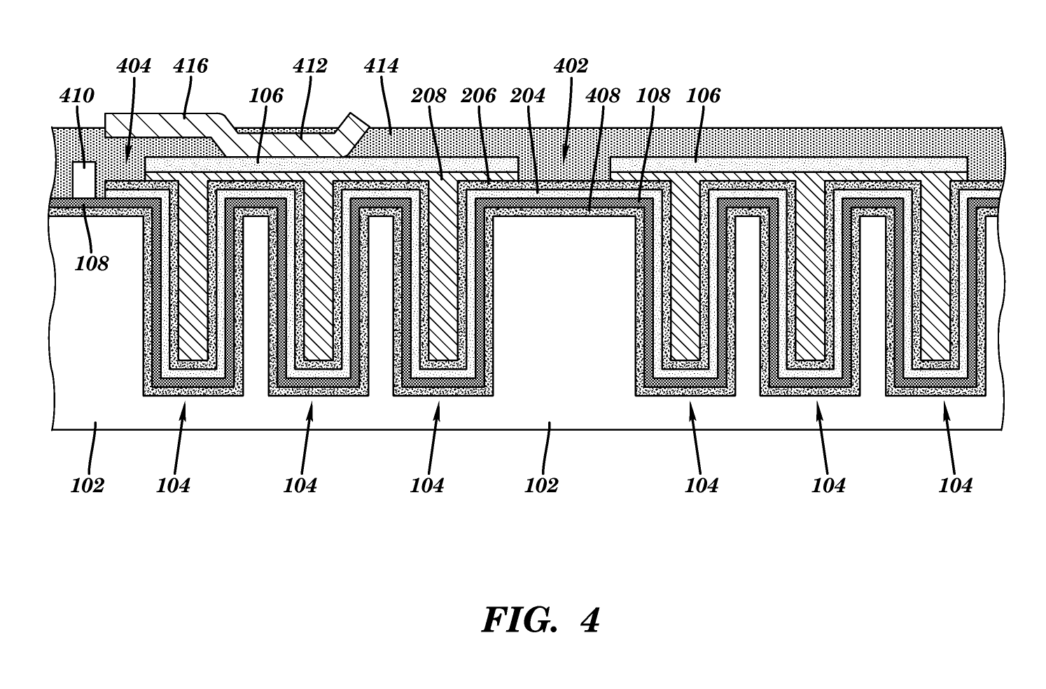

FIG. 4 illustrates a cross-section view of the solid-state battery structure of FIG. 3. It should be noted that in the conventional solid-state battery depicted in FIG. 2, the battery structure is not electrically separated from semiconductor substrate 102. An embodiment of the present invention contemplates a battery structure that is insulated from semiconductor substrate 102 by a first insulating layer 408. According to this embodiment, once trenches 104 are formed in substrate 102, first insulating layer 408 is deposited, as a conformal layer, on sidewalls and the bottom of trenches 104. First insulating layer 408 may also be deposited onto the surface of substrate 102 in between trenches 104. First insulating layer 408 may be formed of any suitable insulating material, such as silicon dioxide, silicon nitride, silicon oxy-nitride, or the like. The first insulating layer 408 may be deposited via CVD, high density plasma-chemical vapor deposition (HDP-CVD), ALD, metal organic chemical vapor deposition (MOCVD), PVD, jet vapor deposition (JVD), or another deposition technique, or may be formed by other techniques, for instance via thermal oxidation. In this embodiment, first insulating layer 408 may be deposited to a thickness of approximately 50 nm-1 μm. First insulating layer 408 isolates battery cells 104 from semiconductor substrate 102.

It should be further noted that in the conventional solid-state battery structure depicted in FIG. 2 the solid-state electrolyte layer 206 is covered with a continuous layer of second electrode material 208 which may be formed substantially across substrate 102. Furthermore, second current collector layer 106 overlying second electrode layer 208 may be substantially continuous as well. The various embodiments of the present invention, however, contemplate that second electrode layer 208 and second current collector layer 106 will be patterned in accordance with a predetermined arrangement of sub-arrays 301-320 within a battery cell array 300. FIG. 4 illustrates a cross-section of only two sub-arrays, namely 304 and 306. However, all sub-arrays preferably have identical structure. As shown in FIG. 4, portions of second electrode layer 208 and second current collector layer 106 are removed to define each sub-array.

The patterned second electrode 208 shown in FIG. 4 can be formed by various means. For example, standard etch and photolithography can be employed to form patterned second electrode layer 208. Once continuous layers of second electrode material 208 and second current collector material 106 are deposited, as shown in FIG. 2, a photoresist layer (not shown) may be spun on top, patterned/exposed and developed. In the region 402, where there should be no second electrode material, both second electrode layer 208 and second current collector layer 106 may be etched away (dry or wet-chemical etching) and finally, after etching is complete, the residual photoresist layer may be removed. Furthermore, according to this embodiment of the present invention, during the etching step described above, portions of solid-state electrolyte layer 206 and first electrode layer 204 may also be removed around the perimeter of battery array 300 to provide the stair step pattern 404 shown in FIG. 4 along each side of battery structure 300. In other words, second electrode layer 208, electrolyte layer 206 and first current collector layer 108 are progressively offset from one another in the horizontal dimension at each perimeter edge of battery array 300. This stair step pattern 404, advantageously reduces leakage around the perimeter of battery array 300 because second electrode layer 208 is horizontally offset from the electrolyte layer 206, as shown in FIG. 4.

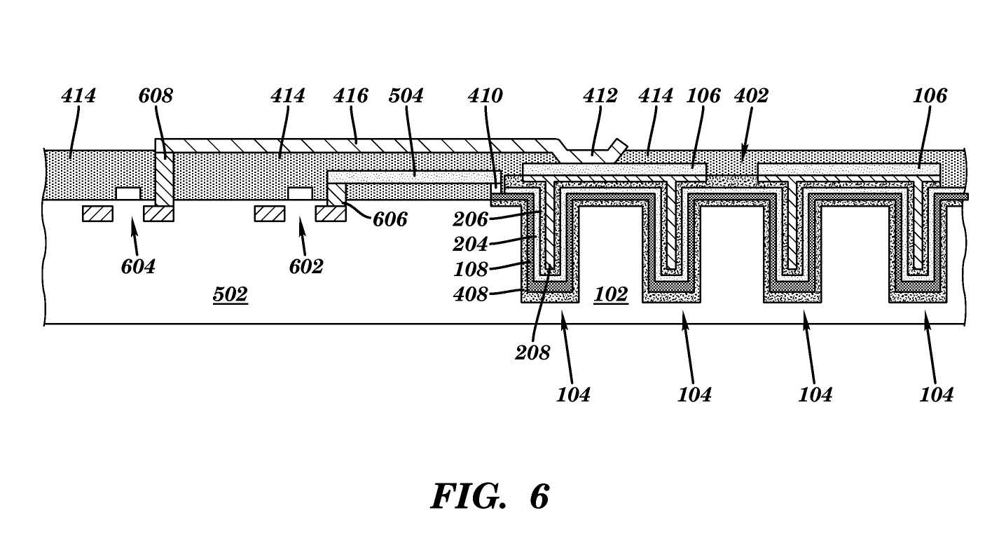

According to an embodiment of the present invention, battery structure 300 may further include second insulating layer 414. Second insulating layer 414 may facilitate electrical connection of battery structure with an adjacent circuit 502, shown in FIGS. 5 and 6. Second insulating layer 414 may be formed over second current collector layer 106 and over solid-state electrolyte layer 206 in region 402, as shown in FIG. 4. In an embodiment, second insulating layer may comprise one or more layers of conventional BEOL interconnect structure discussed bellow in conjunction with FIGS. 5 and 6. Second insulating layer 414 may be formed of any suitable insulating material, such as silicon dioxide, undoped silicate glass (USG), fluorinated silicon glass (FSG), SiCOH, porous SiCOH, or the like. Second insulating layer 414 may be deposited using CVD, plasma enhanced chemical vapor deposition (PECVD), sputter deposition, and the like. In the present embodiment, second insulating layer 414 may comprise a thickness of approximately 0.2 μm to approximately 10 μm.

As shown in FIG. 4, the battery structure can further include first contact pad 410 and second contact pad 412 formed within second insulating layer 414 so that first contact pad 410 is electrically connected to first current collector layer 108 and second contact pad 412 is electrically connected to second current collector layer 106, respectively. Contact pads 410 and 412 may comprise any suitable conducting material, including, but not limited to, copper, copper alloy, gold, silver, nickel , aluminum, or the like. First contact pad 410 and second contact pad 412 may be formed in second insulating layer 414 using conventional semiconductor processing techniques, such as, for example, masking and etching second insulating layer 414 in a prescribed pattern. In an embodiment, one may use photolithography and RIE to etch portions of second insulating layer 414. Subsequently, one or more conductive materials may be deposited in the etched portions of second insulating layer 414 using known deposition techniques. As shown in FIG. 4, second contact pad 412 may be electrically connected to one of the BEOL wiring levels 416, discussed below in conjunction with FIGS. 5 and 6, so that the battery can be electrically connected to a device in need of battery power. Although not shown in FIG. 4, in an embodiment, first contact pad 410 may be also connected to one or more BEOL wiring levels in a similar fashion. In some embodiments, the device in need of battery power is a circuit.

Referring back to FIG. 3, the present invention contemplates a fuse connection structure integrated with the battery. Fuse connection structure depicted in FIG. 3 comprises a plurality of substantially parallel fuse wires such as 320, 322, and 324 interconnecting sub-arrays in each column of the array 300. In other words, fuse wire 320 interconnects sub-arrays 302, 314, and 316 in the rightmost column of array 300, fuse wire 322 interconnects sub-arrays 308, 310, and 312 in the second column from the right side, and so on, and fuse wire 324 interconnects sub-arrays 301, 303, and 304 in the leftmost column of array 300. The fuse connection structure depicted in FIG. 3 further comprises interconnect wire 326 that connects fuse wires 320, 322, and 324. Preferably, fuse wires 320 through 326 are of the same material as second current collector layer 106 previously described. It should be noted that first current collector layer 108 and electrolyte layer 206 are shown in FIG. 3 to illustrate the stair step pattern 404 described above in conjunction with FIG. 4.

In various embodiments of the present invention two types of fuses may be used. In one type, the fuse may be blown using an external heat source, for example, a laser beam. In a second type, an electrical current may be flowed through the fuse wire to blow the fuse. The latter type, electrical fuse (E-fuse), is preferred because the fuse blow operation can be automated in conjunction with a battery test.

The solid-state battery depicted in FIG. 3 may be tested for defects prior to packaging. It is known in the art to use battery test equipment to test every cell 104 of battery array 300. Such test equipment may include, for instance, a battery tester with an integrated battery cell temperature sensor. The temperature sensor is a non-contact sensor which is capable of measuring the temperature of a particular cell 104 when positioned proximate the particular cell 104. One example of a non-contact sensor which is suitable for use with the present invention is an infrared (IR) temperature sensor. Cell temperature measurements may be carried out by aiming or directing a laser beam from the IR sensor at different points on the surface of battery.

At each different point, IR radiation that is emitted from the target cell 104 is focused onto an IR detector of the sensor, which determines the temperature of the target cell 104 as a function of the radiation emitted from the target. By comparing the temperature measurements with one or more predetermined temperature thresholds, the battery tester may indicate whether an open circuit condition, short circuit condition, and the like is present in any of the cells 104 within battery cell array 300. It is also to be understood that alternative methods of testing battery cells 104 may be employed.

Once sub-arrays with one or more defective battery cells are identified, a fuse blow operation may be performed to disconnect defective sub-arrays from the battery array 300. For purposes of illustration, assume that only one defective cell 104 was detected in sub-array 312. Fuse wire 322 may be blown by either using an external heat source, such as laser beam, or by flowing a high voltage electrical current through the fuse wire 322. Fuse wire 322 evaporates or melts under the influence of a high voltage current. It should be noted that in this embodiment sub-arrays 308 and 310 will be eliminated along with sub-array 312 because the entire fuse wire 322 is blown.

FIG. 5 illustrates a top view of a solid-state battery structure of FIG. 3 integrated with a circuit on a same substrate. According to the present embodiment of the invention, circuit 502 is fabricated first (for example, an integrated circuit built onto a silicon substrate 102), and later battery 300 is fabricated adjacent to circuit 502 on the same substrate 102. In addition, the structure shown in FIG. 5 includes one or more electrical wiring levels 416 and 504 that are used to connect battery 300 with one or more components of circuit 502. In some embodiments, circuit 502 comprises a complementary metal-oxide-semiconductor (CMOS) circuit fabricated on substrate 102. CMOS circuits, such as circuit 502 shown in FIGS. 4 and 5, typically include a plurality of wiring levels, known in the art as BEOL wiring levels, which interconnect individual devices within such integrated circuits. In various embodiments, wires 416 and 504 may be present on either the same or different wiring levels of the conventional BEOL interconnect structure. BEOL wiring levels typically comprise vias and lines which contain conventional conductive materials, such as metals, noble-metals, conductive nitrides, nobel metal oxides and mixtures or multilayers thereof. Exemplary BEOL conductive materials include: Cu, W, Al, Pt, or the like. Disclosed embodiments can be applied to BEOL stacks generally comprising any number of wiring levels. By way of example but not limitation, wire 504 may comprise second wiring level, while wire 416 may comprise fifth wiring level, respectively, of an exemplary ten level BEOL stack. The various wiring levels may be composed of the same or different conductive material. In FIG. 5 wires 416 and 504 are depicted as being composed of the different conductive materials. Various embodiments of the present invention allow for the formation of the interconnecting wires 416 and 504 during normal BEOL interconnect process flows, advantageously reducing processing costs for manufacturing such wires which are normally fabricated in different process flows.

FIG. 6 illustrates a cross-section view of the integrated structure of FIG. 5. An exemplary CMOS circuit 502 of the present embodiment of the invention comprises semiconductor substrate 102 having at least one n-FET device 602 and at least one p-FET device 604 formed adjacent to each other. In this exemplary embodiment, first wiring level 504 electrically connects, through the first contact pad 410, first current collector layer 108 with a first device (n-FET 602) and second wiring level 416 electrically connects, through the second contact pad 412, second current collector layer 106 with a second device (p-FET 604). Although, FIG. 6 shows that first wiring level 416 is electrically connected to first current collector layer 108 using first contact pad 410, in an alternative embodiment first wiring level 416 may comprise an extension portion of first current collector layer 108. This extension portion may be fabricated during at least a portion of the step of depositing first current collector layer 108. In this alternative embodiment, first contact pad 410 would not be needed. Referring back to the embodiment depicted in FIG. 6, conductive vias 606 and 608 may be employed to connect first wiring level 504 with first device 602 and to connect second wiring level 416 with second device 604, respectively. Conductive vias 606 and 608 may be formed using a well-known in the art damascene techniques for interconnecting BEOL wiring levels. These damascene techniques can employ tungsten, copper, aluminum, or the like as the conductive material. Note that in FIG. 6, which is not drawn to scale, only one n-FET device 602 and one p-FET device 604 are shown on semiconductor substrate 102. Although illustration is made to such an embodiment, various embodiments of the present invention are not limited to any specific number of n-FET devices 602 and p-FET devices 604. Further, the semiconductor devices of CMOS circuit 502 may also contain other logic circuitry components, such as resistors, diodes, planar capacitors, varactors, or the like, in addition to the n-FETs and p-FETs.

The illustrations of the embodiments described herein are intended to provide a general understanding of the structure and method of forming a solid-state battery integrated with CMOS devices on a same chip. Thus, one or more of the different advantageous embodiments of the present invention provide a capability of interconnecting the battery with the CMOS circuit during normal BEOL interconnect process flows, favorably reducing processing costs for manufacturing such interconnected structure on the same chip. In addition, one or more embodiments of the present invention enable one to isolate the solid-state battery from the underlying substrate.

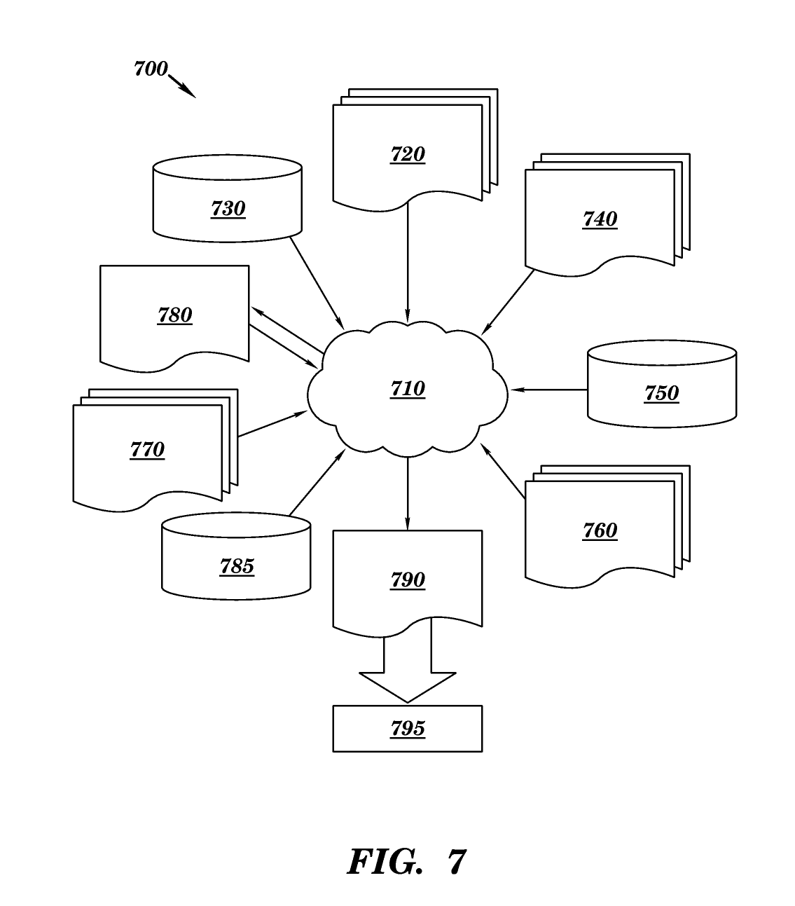

FIG. 7 shows a block diagram of an exemplary design flow 700 used for example, in semiconductor IC logic design, simulation, test, layout, and manufacture. Design flow 700 includes processes, machines and/or mechanisms for processing design structures or devices to generate logically or otherwise functionally equivalent representations of the design structures and/or devices described above and shown in FIGS. 3-6. The design structures processed and/or generated by design flow 700 may be encoded on machine-readable transmission or storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g., e-beam writers), computers or equipment for simulating design structures, any apparatus used in the manufacturing or test process, or any machines for programming functionally equivalent representations of the design structures into any medium (e.g., a machine for programming a programmable gate array).

Design flow 700 may vary depending on the type of representation being designed. For example, a design flow 700 for building an application specific IC (ASIC) may differ from a design flow 700 for designing a standard component or from a design flow 700 for instantiating the design into a programmable array, for example a programmable gate array (PGA) or a field programmable gate array (FPGA) offered by Altera® Inc. or Xilinx® Inc.

FIG. 7 illustrates multiple such design structures including an input design structure 720 that is preferably processed by a design process 710. Design structure 720 may be a logical simulation design structure generated and processed by design process 710 to produce a logically equivalent functional representation of a hardware device. Design structure 720 may also or alternatively comprise data and/or program instructions that when processed by design process 710, generate a functional representation of the physical structure of a hardware device. Whether representing functional and/or structural design features, design structure 720 may be generated using electronic computer-aided design (ECAD), such as implemented by a core developer/designer. When encoded on a machine-readable data transmission, gate array, or storage medium, design structure 720 may be accessed and processed by one or more hardware and/or software modules within design process 710 to simulate or otherwise functionally represent an electronic component, circuit, electronic or logic module, apparatus, device, or system, such as those shown in FIGS. 3-6. As such, design structure 720 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages, such as Verilog and VHDL, and/or higher level design languages, such as C or C++.

Design process 710 preferably employs and incorporates hardware and/or software modules for synthesizing, translating, or otherwise processing a design/simulation functional equivalent of the components, circuits, devices, or logic structures shown in FIGS. 3-6 to generate a netlist 780 which may contain design structures, such as design structure 720. Netlist 780 may comprise, for example, compiled or otherwise processed data structures representing a list of wires, discrete components, logic gates, control circuits, I/O devices, models, etc. that describes the connections to other elements and circuits in an integrated circuit design. Netlist 780 may be synthesized using an iterative process in which netlist 780 is resynthesized one or more times depending on design specifications and parameters for the device. As with other design structure types described herein, netlist 780 may be recorded on a machine-readable data storage medium or programmed into a programmable gate array. The medium may be a non-volatile storage medium, such as a magnetic or optical disk drive, a programmable gate array, a compact flash, or other flash memory. Additionally, or in the alternative, the medium may be a system or cache memory, buffer space, or electrically or optically conductive devices and materials on which data packets may be transmitted and intermediately stored via the Internet, or other networking suitable means.

Design process 710 may include hardware and software modules for processing a variety of input data structure types including netlist 780. Such data structure types may reside, for example, within library elements 730 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 740, characterization data 750, verification data 760, design rules 770, and test data files 785 which may include input test patterns, output test results, and other testing information. Design process 710 may further include, for example, standard mechanical design processes, such as stress analysis, thermal analysis, mechanical event simulation, process simulation for operations, such as casting, molding, and die press forming, etc. One of ordinary skill in the art of mechanical design can appreciate the extent of possible mechanical design tools and applications used in design process 710 without deviating from the scope and spirit of the invention. Design process 710 may also include modules for performing standard circuit design processes, such as timing analysis, verification, design rule checking, place and route operations, etc.

Design process 710 employs and incorporates logic and physical design tools, such as HDL compilers and simulation model build tools to process design structure 720 together with some or all of the depicted supporting data structures along with any additional mechanical design or data (if applicable), to generate a second design structure 790. Design structure 790 resides on a storage medium or programmable gate array in a data format used for the exchange of data of mechanical devices and structures (e.g., information stored in an IGES, DXF, Parasolid XT, JT, DRG, or any other suitable format for storing or rendering such mechanical design structures). Similar to design structure 720, design structure 790 preferably comprises one or more files, data structures, or other computer-encoded data or instructions that reside on transmission or data storage media and that when processed by an ECAD system generate a logically or otherwise functionally equivalent form of one or more of the embodiments of the invention shown in FIGS. 3-6. In an embodiment, design structure 790 may comprise a compiled, executable HDL simulation model that functionally simulates the devices shown in FIGS. 3-6.

Design structure 790 may also employ a data format used for the exchange of layout data of integrated circuits and/or symbolic data format (e.g., information stored in a GDSII (GDS2), GL1, OASIS, map files, or any other suitable format for storing such design data structures). Design structure 790 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown in FIGS. 3-6. Design structure 790 may then proceed to a stage 795 where, for example, design structure 790 proceeds to tape-out, is released to manufacturing, is released to a mask house, is sent to another design house, is sent back to the customer, etc.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A battery structure comprising:
a substrate;
a plurality of battery cells formed in the substrate, the plurality of battery cells comprising a first current collector layer overlying a first insulating layer and a first electrode layer overlying the first current collector layer;
a second current collector layer overlying a patterned second electrode layer, the patterned second electrode layer overlies the substrate and forms a plurality of sub-arrays of the battery cells; and
a second insulating layer overlying the second current collector layer, the second insulating layer substantially laterally surrounding first and second contact pads, the first contact pad electrically connected to the first current collector layer and the second contact pad electrically connected to the second current collector layer, the first contact pad and the second contact pad are in electrical communication, through at least two electrical wires, with a circuit located upon the substrate.

2. The battery structure of claim 1, wherein the circuit comprises a complementary metal-oxide-semiconductor (CMOS) circuit located upon the substrate.

3. The battery structure of claim 2, wherein the CMOS circuit comprises at least one n-FET device and at least one p-FET device.

4. The battery structure of claim 1, wherein the at least two electrical wires comprise at least two back-end-of-line (BEOL) wiring levels.

5. The battery structure of claim 4, wherein a first electrical wire of the at least two BEOL wiring levels electrically connects, through the first contact pad, the first current collector layer with a first device of the circuit and wherein a second electrical wire of the at least two BEOL wiring levels electrically connects, through the second contact pad, the second current collector layer with a second device of the circuit.

6. The battery structure of claim 1, wherein the first current collector layer has an extension portion extending toward the circuit and wherein the extension portion comprises one of the at least two electrical wires.

7. The battery structure of claim 1, wherein the first insulating layer has a thickness ranging from approximately 50 nm to approximately 1 μm and the second insulating layer has a thickness ranging from approximately 0.2 μm to approximately 10 μm.

8. The battery structure of claim 1, wherein the first contact pad and the second contact pad are located on a top surface of the battery structure.

9. The battery structure of claim 1, wherein the first electrode layer is an anode electrode layer and the patterned second electrode layer is a cathode electrode layer and wherein the first current collector layer is an anode current collector layer and the second current collector layer is a cathode current collector layer.

10. A method of forming a battery structure comprising:
forming a plurality of battery cells in a substrate, the plurality of battery cells having a first insulating layer and a first current collector layer;
forming a second current collector layer overlying the plurality of battery cells;
forming a second insulating layer overlying the second current collector layer;
forming first and second contact pads in the second insulating layer, the first contact pad electrically connected to the first current collector layer and the second contact pad electrically connected to the second current collector layer; and
connecting the first contact pad and the second contact pad, through at least two electrical wires, with a circuit located upon the substrate.

11. The method of claim 10, wherein forming the plurality of battery cells comprises:
forming a plurality of trenches having sidewalls and a bottom in the substrate;
forming the first insulating layer on the sidewalls and the bottom of the plurality of trenches and upon a surface of the substrate between the plurality of trenches;
forming the first current collector layer overlying the first insulating layer;
forming a first electrode layer overlying the first current collector layer;
forming an electrolyte layer overlying the first electrode layer;
forming a second electrode layer overlying the electrolyte layer; and
patterning the second electrode layer to define a plurality of sub-arrays of the battery cells.

12. The method of claim 10, wherein the circuit comprises a complementary metal-oxide-semiconductor (CMOS) circuit located upon the substrate.

13. The method of claim 12, wherein the CMOS circuit comprises at least one n-FET device and at least one p-FET device.

14. The method of claim 10, wherein the at least two electrical wires comprise at least two back-end-of-line (BEOL) wiring levels.

15. The method of claim 14, wherein connecting the first contact pad and the second contact pad further comprises connecting the first contact pad, through a first wire of the at least two BEOL wiring levels, with a first device of the circuit and connecting the second pad, through a second wire of the at least two BEOL wiring levels, with a second device of the circuit.

16. The method of claim 10, further comprising forming an extension portion horizontally extending from the first current collector layer toward the circuit, the extension portion comprises one of the at least two wires.

17. The method of claim 10, wherein the first insulating layer has a thickness ranging from approximately 50 nm to approximately 1 μm and the second insulating layer has a thickness ranging from approximately 0.2 μm to approximately 10 μm.

18. The method of claim 10, wherein forming the first pad and the second pad further comprises forming the first pad and the second pad on a top surface of the battery structure.

19. A design structure tangibly embodied in a machine readable medium for designing, manufacturing, or testing an integrated circuit, the design structure comprising:
a substrate;
a plurality of battery cells formed in the substrate, the plurality of battery cells comprising a first current collector layer overlying a first insulating layer and a first electrode layer overlying the first current collector layer;
a second current collector layer overlying a patterned second electrode layer, the patterned second electrode layer overlies the substrate and forms a plurality of sub-arrays of the battery cells; and
a second insulating layer overlying the second current collector layer, the second insulating layer substantially laterally surrounding first and second contact pads, the first contact pad electrically connected to the first current collector layer and the second contact pad electrically connected to the second current collector layer, the first contact pad and the second contact pad are in electrical communication, through at least two electrical wires, with a circuit located upon the substrate.

20. The design structure of claim 19, wherein the design structure resides in a programmable gate array.
